(19) United States
(12) Patent Application Publication
(10) Pub. No.: US 2004/0158630 A1
(43) Pub. Date: Aug. 12, 2004

(54) Monitoring and controlling network activity in real-time

(76) Inventors: Tsung-Yen Dean Chang, Los Altos Hills, CA (US); Chuang Li, Saratoga, CA (US); Bo Xiong, Fremont, CA (US)

Correspondence Address: FISH & NEAVE, 1251 AVENUE OF THE AMERICAS, 50TH FLOOR, NEW YORK, NY, 10020-1105, US

(21) Appl. No.: 10/366,028

(22) Filed: Feb. 12, 2003

(51) Int. Cl. G06F 15/173

(52) U.S. Cl. 709/224

(57) ABSTRACT

A method for monitoring and controlling network activity of one or more network appliances in real-time is provided. The network activity of a network appliance may be monitored by the network appliance itself or, if the network appliance is in a LAN, by a network gateway in the LAN. The network activity is transmitted to one or more controlling network appliances based on which type of IP address is assigned to the monitoring network appliances and the controlling network appliances. The controlling network appliances control the network activity of the monitored network appliances by sending a command to the monitored network appliances with or without user intervention. The monitored network appliances execute the command to control their network activity in real-time.

### FIELD OF THE INVENTION

This invention relates generally to a system and method for monitoring and controlling network activity. More specifically, the present invention provides a system and method for real-time monitoring and controlling of network activity by broadcasting network activity information in real-time to multiple controlling network appliances without user intervention.

### BACKGROUND OF THE INVENTION

The popularity of the Internet has grown rapidly over the past several years. A decade ago, the Internet was limited to the academic and research community. Today, the Internet has grown into a communications network that reaches millions of people around the world. It provides a powerful and versatile environment for business, education, and entertainment. At any given time, massive amounts of digital information are accessed and exchanged on the Internet by millions of users worldwide with many diverse backgrounds and personalities, including children, students, educators, business men and women, and government officials, among others.

Users may access the Internet through a dial-up modem connected to existing telephone lines, or through high-speed connections including a direct connection to the Internet backbone and connections provided by T1 or T3 lines leased from telephone companies, cable modems, or DSL modems. These high-speed connections may be shared by multiple users on a local area network (“LAN”) through the use of a router, which is a device that handles all the digital information traffic between the Internet and each one of the users in the LAN.

The digital information may be accessed and exchanged through the World Wide Web (hereinafter the “web”), or by using electronic mail, file transfer protocols, or a variety of other applications, including peer-to-peer (“Pr2Pr”) file sharing systems and Instant Messaging (“IM”). Information on the web is typically viewed through a “web browser” such as Internet Explorer, available from Microsoft Corporation, of Redmond, Wash. The web browser displays multimedia compositions called “web pages” that contain text, audio, graphics, imagery and video content, as well as nearly any other type of content that may be experienced through a computer or other network appliance. Network appliances are electronic devices configured with a network access system, such as personal and portable computers, electronic organizers, personal digital assistants (“PDAs”), and wireless telephones, among others.

Besides the web, Pr2Pr file sharing systems and IM have become increasingly popular vehicles for exchanging digital information. Pr2Pr file sharing systems enable users to connect to each other and directly access files from one another's network appliances. Such systems are mostly used for exchanging digital music or image files on the Internet. Examples include the open source systems Gnutella and Napigator.

In addition to digital files, users may also exchange messages with one another by using an IM service. An IM service is primarily used by a subscriber to “chat” with one or more other IM subscribers. Because the exchange of information is almost instantaneous, IM is quicker than ordinary electronic mail and a more effective way to communicate with other users.

To access an IM service, a user registers with an IM service provider to become a subscriber, and, after downloading and installing “IM client” software, connects to the Internet (or other appropriate data network), and enters a selected username and password to log in to an “IM server” maintained by the IM service provider. The IM server maintains a contact list or “buddy list” for each subscriber to allow the subscriber to send an instant message to any one in his/her buddy list, as long as that person, commonly referred to as a “buddy”, is also online. In addition, a subscriber may enter a “chat room” to communicate to any subscriber in the room.

Once a subscriber has logged in to the IM server, his/her presence on the network is made known to all of his/her buddies on his/her buddy list. The subscriber can then engage in typed conversations with his/her buddies and update his/her buddy list to include other subscribers that they desire to communicate with. Because of ease of use and convenient buddy lists, IM has become especially popular among children and teens. Popular IM applications include the freely-distributed ICQ, AOL Instant Messenger (“AIM”), provided by America Online, Inc., of Dulles, Va., Yahoo! Messenger, provided by Yahoo!, Inc., of Sunnyvale, Calif., and MSN Messenger, provided by Microsoft Corporation, of Redmond, Wash.

With the ease of access and distribution of digital information over the Internet, it has become increasingly important to block or filter out offensive or objectionable material that is not appropriate to all users. In particular, adult content displayed on the web may not be appropriate for children, teenagers, or employees during their work hours, and IM exchanges between children, teenagers or employees and certain users may not be acceptable to parents or employers. Furthermore, it may not be acceptable to parents or employers to have their children or employees using IM for long periods of time, or using a Pr2Pr system to exchange inappropriate files. It is therefore important to parents and employers to monitor and block exchanges on the web and other applications such as electronic mail, Pr2Pr systems, and IM.

In response to this need, a number of parental control software programs have been developed to filter out inappropriate content on the web or on other electronic media including CDs and DVDs. These filtering systems may be classified into one or a combination of four major categories: (1) rating-based systems; (2) list-based systems; (3) keyword-based systems; and (4) context-based systems.

A typical rating-based system, such as the SuperScout Web filter developed by Surf Control, Inc., of Scotts Valley, Calif., classifies web sites into different categories based on their content and enables users to define rules that govern access to the different categories. For example, a parent may define a rule allowing access to web sites belonging to an “educational” category and block access to web sites in an “adult” category. While rating-based systems allow users to rely on trusted authorities to categorize web site content, they are not always reliable because many web sites frequently change their content and their classification before the rating-based systems are updated to reflect the changes.

An alternative to using rating-based systems to filter out inappropriate content involves using list-based systems that maintain lists of inappropriate and objectionable web sites, newsgroups, and chat rooms that may be selected by users for blocking, or using keyword-based systems that filter content based on the presence of inappropriate or offending keywords or phrases. However, list-based systems, such as Net Nanny, developed by Net Nanny Software International, Inc., of Vancouver, BC, Cyber Patrol, developed by Surf Control, Inc., of Scotts Valley, Calif., and Cyber Sitter, developed by Solid Oak Software, Inc., of Santa Barbara, Calif., are also unreliable because new web sites, newsgroups, and chat rooms are constantly appearing, and the lists, even when updated, are obsolete as soon as they are released.

In addition, keyword-based systems, such as the Cyber Sentinel system developed by Security Software Systems, of Sugar Grove, Ill., also produce poor results since they are likely to block sites that should not be blocked while letting many inappropriate sites pass through unblocked. Because they are based on text recognition, keyword-based systems are unable to block offensive or inappropriate pictures.

To make keyword-based systems more effective, context-based systems, such as the I-Gear web filter developed by Symantec Corporation, of Cupertino, Calif., have been developed to perform a contextual analysis of a web site to be blocked. The I-Gear system employs context-sensitive filtering based on a review of the relationship and proximity of certain inappropriate words to other words on the web site. While I-Gear and other context-based systems are more effective than individual keyword-based systems, they lack the ability to filter electronic content other than text on web pages, and therefore are not guaranteed to block a site containing inappropriate pictures.

In addition to unreliability in blocking unwanted web site material, all of the above mentioned filtering systems do not monitor content that is exchanged through non web-based applications, such as electronic mail and IM. Software monitoring programs, such as Online Recorder, provided by Morrow International, Inc., of Canton, Ohio, and ChatNanny, provided by Tybee Software, Inc., monitor online activity in instant messages, chat rooms, electronic mail, etc., and record the monitored information for later viewing. For example, a parent may install a monitoring program on his children's machines to record his children's online activity, including their IM usernames and passwords, and later access a password protected information viewer provided with the monitoring software to view a record of his children's online activity on any given day.

Although these programs give parents or employers accurate information of the content of messages exchanged via IM or electronic mail and the location of web sites visited, they can only produce a historical account of the users' activity. That is, they are not able to provide real-time monitoring to prevent the unwanted activity from occurring, or stop undesirable activity as it is happening. The monitoring programs may be used solely for monitoring purposes and are not able to perform any actions on the monitored user, such as blocking the user from seeing a particular web site. Furthermore, in order for these monitoring programs and other web-filtering systems to be effective, they must be installed on every network appliance that is to be monitored.

Besides the above mentioned software monitoring programs, some hardware products, such as the RP614 router, provided by NETGEAR, Inc., of Santa Clara, Calif., have limited monitoring capabilities. The RP614 router may be configured to provide reports of online activity for every appliance in a LAN and also limit access to predetermined web sites. However, this router does not provide real-time monitoring functionality and its ability to prevent unwanted material from being accessed is limited to the predetermined web sites. Additionally, the user must log on to the router in order to obtain activity reports, and therefore is not able to remotely monitor network activity from a device outside the LAN.

Network activity may be monitored remotely with the use of remote network management software, including Netop, provided by Danware Data A/S, of Birkerod, Denmark, pcAnywhere, provided by Symantec Corporation, of Cupertino, Calif., and GoToMyPC, provided by Expertcity, of Santa Barbara, Calif. These applications enable users to view the screen and control the keyboard, mouse, files, resident software, and network resources of any remote computer, regardless of its location. For example, a parent may use one of these applications to monitor his children's computers at home while the parent is away on a business trip and an IT employee at a company may use one of these applications to help a company's employee solve a problem, install a software, or perform other actions on the employee's laptop computer while the employee is away from his office. In short, these applications enable users to monitor and control a computer or network remotely and to perform all actions as though they were there in person.

The drawback is that these applications may be slow and generate unnecessary traffic when used to monitor network activity of a remote computer. Since most of these applications transmit the image of the screen of the remote computer being monitored instead of transmitting the network traffic, i.e., packets, generated by the activity, the unnecessary traffic generated is in the form of screen backgrounds and other graphic displays, local application and other pop-up windows, error messages, etc. Transmitting this unnecessary traffic may result in delays, which may ultimately prevent the activity from being monitored in real-time.

Additionally, these applications may require the user monitoring the remote computer to send a request to a server or to the remote computer every time the user desires to view information pertaining to activities in the remote computer. That is, these applications may not be used to monitor remote network activity in real-time without user intervention. Further, these applications may not be used to enable a device to monitor the activity of another remote device without user intervention.

In view of the foregoing, it would be desirable to provide systems and methods for real-time monitoring and controlling of local network activity.

It further would be desirable to provide systems and methods for one or more monitoring network appliances to monitor their own network activity and transmit their own network activity information in real-time to one or more controlling users and controlling network appliances without user intervention.

It also would be desirable to provide systems and methods for one or more monitoring network appliances to monitor their own network activity, communicate their own monitoring information to one or more controlling users and controlling network appliances and respond to commands from the controlling users or controlling network appliances to perform actions that control the network activity of the one or more monitoring network appliances in real-time.

It also would be desirable to provide systems and methods for a monitoring network appliance to monitor network activity and transmit network activity information in real-time to a controlling network appliance without user intervention and using a communication routine selected from a plurality of communication routines to transmit the network activity information based on the IP addresses of the monitoring network appliance and the controlling network appliance.

### SUMMARY OF THE INVENTION

In view of the foregoing, it is an object of the present invention to provide systems and methods for real-time monitoring and controlling of local network activity without user intervention.

It is a further object of the present invention to provide systems and methods for one or more monitoring network appliances to monitor their own network activity and transmit their own network activity information in real-time to one or more controlling users and controlling network appliances without user intervention.

It is also an object of the present invention to provide systems and methods for one or more monitoring network appliances to monitor their own network activity, communicate their own monitoring information to one or more controlling users and controlling network appliances and respond to commands from the controlling users or controlling network appliances to perform actions that control the network activity of the one or more monitoring network appliances.

It is also an object of the present invention to provide systems and methods for a monitoring network appliance to monitor network activity and transmit network activity information in real-time to a controlling network appliance without user intervention and using a communication routine selected from a plurality of communication routines to transmit the network activity information based on the IP addresses of the monitoring network appliance and the controlling network appliance.

These and other objects of the present invention are accomplished by providing a system and method for one or more network appliances to monitor their own network activity and transmit network activity information in real-time to one or more controlling users and network appliances without user intervention. A network appliance is an electronic device configured with a network access system for connecting to a network and sharing resources and information with other network appliances on the network, such as a personal and portable computer, an electronic organizer, a personal digital assistant (“PDA”), a wireless telephone, an entertainment system, a stereo system, a video game unit, a household appliance, or any other embedded electronic device, among others.

The network activity information may correspond to the network activity of one or more network appliances directly connected to the Internet or the network activity of one or more network appliances in a local area network (“LAN”) connected to the Internet by means of a network gateway, which is an embedded device that acts as an entrance to another network, such as a router, a modem, switch, hub, bridge, or other embedded device. In both cases, the network activity information may be broadcasted to one or more controlling users or network appliances that desire to monitor and control the network activity.

The network appliances or the network gateway in the LAN to be monitored are hereinafter interchangeably referred to as monitoring network appliances (“MNAs”). A MNA is a network appliance equipped with a monitoring engine, which is a program capable of reading the contents of each network packet transmitted from/to it to/from the Internet and determining the network activity represented in the packets, such as URLs accessed, chat rooms visited, e-mails sent and received, and instant messaging (“IM”) sessions, among others.

The controlling users and remote network appliances or network gateways receiving the network activity information collected and transmitted by the MNA may act as a controlling network appliance. Alternatively, intelligence can be programmed in the remote network appliances that receive the network activity information collected and transmitted by the MNA such that commands may be automatically sent from the remote network appliances to the MNA. In this case, the MNA may be controlled without user intervention. The remote network appliances or network gateways receiving the network activity information collected and transmitted by the MNA, with a controlling user or with programmed intelligence, are hereinafter interchangeably referred to as controlling network appliances (“CNAs”).

The CNAs analyze the information collected by the MNA to determine whether any immediate or future action to control network activity is to be taken. A single CNA may control one or more MNAS, and conversely, a single MNA may send network information to one or more CNAs. In addition, a network appliance may function as a MNA and as a CNA simultaneously.

For example, a parent may install a router in his home network that acts as a MNA to monitor the online activity of his children. The MNA collects information about all packets transmitted from/to the children's computers to the Internet, including URLs accessed, chat rooms visited, e-mails sent and received, and IM session transcripts between the children and their buddies, and transmits the collected information to the parent, i.e., the controlling user. The MNA may transmit the information to the controlling user in real-time when the controlling user is online, it may record the information in a log and transmit the log to the controlling user when the controlling user goes online or transmit the log to the controlling user by e-mail, fax, or other communication means. In all of these cases, the MNA may transmit the information simultaneously to one or more family members, other controlling users and controlling network appliances. The controlling users may access the collected information from a number of CNAs, such as their home computer, their laptop, PDA, cell phone voice file, or from their business computers located in their company's LAN.

The information is preferably transmitted point-to-point (“P2P”) between the MNAs and CNAs. A P2P transmission involves the transmission of network packets, e.g., IP or TCP/IP packets, between two parties and may occur whenever the parties are assigned a communicable IP address, e.g., a public IP address. A communicable IP address is an IP address assigned to a network appliance that is reachable from any device in the Internet. Alternatively, if one or both parties are assigned a private and non-communicable IP address, the transmission may be a hybrid point-to-point (“H-P2P”) transmission or a client-server transmission as described hereinbelow. A private IP address is an IP address that is not reachable by an outside network, such as an IP address assigned to a network appliance in a LAN that has a gateway configured with network address translation (“NAT”). Since a private IP address is not Internet routable, a sender of information may not transmit information to a private IP address in a point-to-point manner, unless the private IP address is communicable. For example, if both the MNA and the CNA are in the same LAN, they are each assigned private IP addresses that are communicable, that is, the MNA and the CNA may exchange point-to-point messages inside the LAN. Another example is that of a MNA that is behind a network gateway that applies port forwarding to the MNA. In this case, remote CNAs can still send point-to-point messages to the MNA even though the MNA has a private IP address.

An IP address discovery exchange is conducted between the MNA and the CNA to determine the type of IP address assigned to them, i.e., whether their IP addresses are communicable or non-communicable. The IP address discovery exchange is conducted by a connection engine in the MNA and in the CNA. The connection engine connects the MNA to the CNA and determines the communication means to be used for the transmission of network activity information, i.e., P2P, H-P2P, or client-server, as described hereinbelow.

The CNA may passively analyze the information received without performing any action on the MNA or on the LAN monitored by the MNA. Alternatively, the CNA may direct the MNA to perform an action by means of a command set provided in the MNA and in the CNA. For example, the CNA may direct the MNA to block a particular web site or chat room.

In a preferred embodiment, the system and method of the present invention involve six main components embedded in the MNA: (1) a monitoring engine; (2) a connection engine; (3) a communication engine; (4) a command set; (5) a command set interpreter; and (6) a reporting engine. The CNA is equipped with three of the six components: (1) the connection engine; (2) the communication engine; and (3) the command set. In addition, the CNA has a display engine to display the network activity information transmitted by the MNA.

The monitoring engine is a program embedded in the MNA for reading the contents of each network packet transmitted from/to the MNA to/from the Internet and determining the network activity represented in the packets, such as URLs accessed, chat rooms visited, e-mails sent and received, and instant messaging (“IM”) sessions, among others.

The information is transmitted to the CNA via the communication engine in one of four ways, depending on the results of the IP address discovery exchange conducted by the connection engine between the MNA and the CNA: (1) the transmission may be a bi-directional P2P transmission if both the MNA and the CNA have communicable IP addresses; (2) if the MNA has a communicable IP address but the CNA has a non-communicable IP address, the transmission may be a H-P2P transmission where the MNA may designate a local information buffer to store the network activity information for the CNA to pull such information periodically. The MNA may also designate a command buffer to receive commands sent by the CNA periodically; (3) if the MNA has a non-communicable IP address but the CNA has a communicable IP address, the transmission may be a H-P2P transmission where the CNA may designate a local information buffer for the MNA to send the network activity information periodically. The CNA may also designate a local command buffer to store control commands for the MNA to retrieve periodically; and (4) if both the MNA and the CNA have non-communicable IP addresses, the transmission may be a client-server transmission where the MNA and the CNA relay information by means of a server.

The connection engine in the MNA determines the type of IP address assigned to the CNA, i.e., communicable or non-communicable, and selects the corresponding communication means to be used by the communication engine for exchanging network activity information between the MNA and the CNA. In a preferred embodiment, the connection engine may be an instant messaging client (“IMC”) with the MNA and the CNA as buddies in the same IM network. The MNA is logged into an IM server with its own username and password, which may be selected by a controlling user upon the MNA's configuration. The IM server may be any IM server used by an IM service, such as ICQ, AOL Instant Messenger (“AIM”), provided by America Online, Inc., of Dulles, Va., Yahoo! Messenger, provided by Yahoo!, Inc., of Sunnyvale, Calif., and MSN Messenger, provided by Microsoft Corporation, of Redmond, Wash., among others. The IMC is a program for making requests to the IM server, which fulfills the requests. By launching an IMC, the MNA can send instant messages to any user and network appliance on its buddy list.

Once the MNA is logged into an IM server, it sends instant messages containing its IP address to all of its buddies, i.e., to all the CNAs that may monitor and control the network activity collected by the MNA. The instant messages are first sent to the IM server and forwarded to the CNAs if they are online. If a given CNA is not online when an instant message is sent, the IM server stores the instant message for later forwarding. When the CNA goes online, the IM server sends a notification to the MNA to inform the MNA of the CNA's online status and it forwards the instant message containing the MNA's IP address to the CNA. The CNA then replies to the instant message sent by the MNA with an instant message to the MNA containing the CNA's IP address.

Once the MNA has the IP address of the CNA, it uses the communication engine to try to establish a P2P connection with the CNA to determine the type of IP address assigned to the CNA, i.e., communicable or non-communicable, by sending a packet to the CNA. If the CNA has a communicable IP address, it receives the packet and subsequently sends an acknowledgment packet to the MNA. If the CNA has a non-communicable IP address, however, it does not receive the MNA's packet nor it is able to send an acknowledgment packet to the MNA. The MNA determines the type of IP address assigned to the CNA based on whether it receives the acknowledgment packet from the CNA. The MNA then begins to transmit the network activity information to the CNA in one of the four ways described above, depending on the type of IP addresses assigned to the MNA and to the CNA.

After receiving the information from the MNA, the CNA may direct the MNA to perform actions that control the network activity of the MNA, such as blocking access to a given web site or chat room. The CNA directs the MNA to perform an action by using a command in a command set embedded in the MNA. The commands are relayed to the MNA depending on its IP address, as described above.

The command set has a list of commands that a CNA may use to direct the MNA to perform an action that control the network activity of the MNA, such as a “block” command to block the MNA from accessing a web site or chat room, a “disconnect” command to disconnect the MNA from the Internet, and a “time out” command to limit the time the MNA is connected to the Internet, among others. A command set interpreter is provided in the MNA for it to retrieve the command sent by the CNA and execute the command.

The MNA may also include a reporting engine for recording network activity information into logs and sending the logs to the CNA. The logs may be transmitted to the CNA via IM when the CNA is online, posted on a secure web site accessed only by the controlling user with a security key, or transmitted by other means, such as via electronic mail, voice mail, among others.

Advantageously, the systems and methods of the present invention enable one or more MNAs to monitor their own network activity in real-time, communicate monitoring information to one or more CNAs and respond to commands from the CNAs to perform actions that control the network activity of the one or more MNAs in real-time. In addition, the systems and methods of the present invention enable a CNA to access and act upon past recorded network activity.

### BRIEF DESCRIPTION OF THE DRAWINGS

The foregoing and other objects of the present invention will be apparent upon consideration of the following detailed description, taken in conjunction with the accompanying drawings, in which like reference characters refer to like parts throughout, and in which:

FIG. 1 is a schematic diagram of an exemplary embodiment of the network environment in which the present invention operates;

FIG. 2 is a schematic diagram of another exemplary embodiment of the network environment in which the present invention operates;

FIG. 3 is a schematic diagram of the software components used in a preferred embodiment of the present invention;

FIG. 4 is a flow chart for an exemplary IP discovery exchange between a MNA and a CNA;

FIG. 5 is a flow chart for monitoring network activity and communicating the monitored activity to a CNA;

FIG. 6 is a flow chart for performing an action based on monitored network information; and

FIG. 7 is an illustrative diagram of a list of commands in the command set.

### DETAILED DESCRIPTION OF THE DRAWINGS

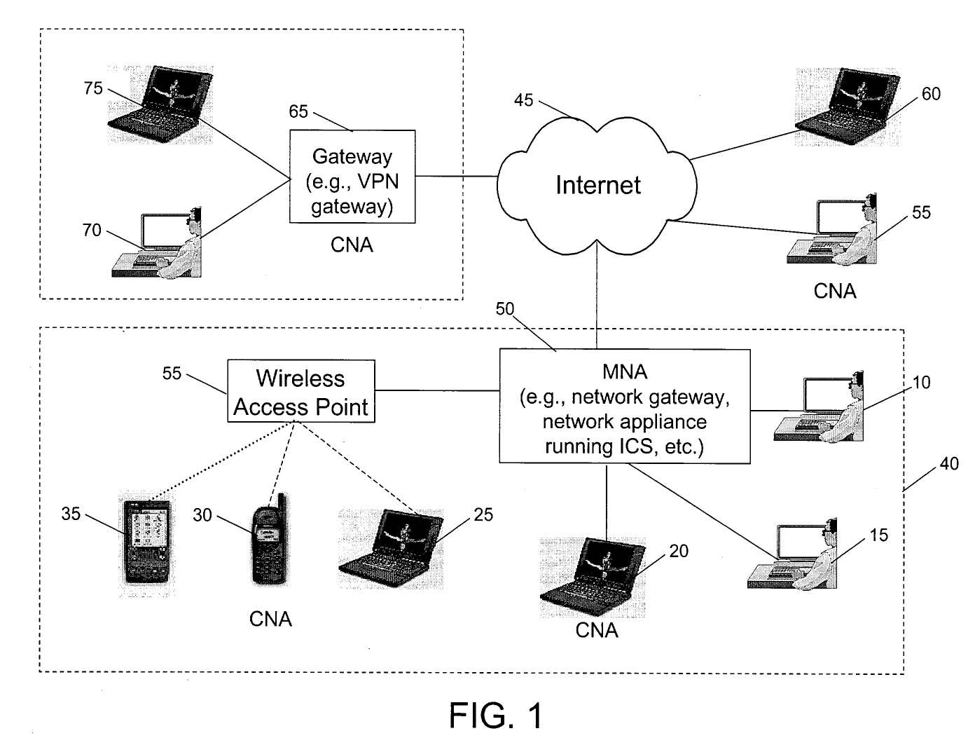

Referring now to FIG. 1, a schematic diagram of an exemplary embodiment of the network environment in which the present invention operates is described. Network appliances 10-35 form local area network (“LAN”) 40 that connects to Internet 45 through MNA 50. Internet appliances 10-20 connect to MNA 50 through a wired connection, while Internet appliances 25-35 connect to MNA 50 by means of a wireless connection through wireless access point 55.

MNA 50 is a network appliance equipped with a monitoring engine, which is a program capable of reading the contents of each network packet transmitted from/to LAN 40 to/from Internet 45 and collecting status information regarding the activity of all network appliances in LAN 40. MNA 50 may be a network gateway that acts as an entrance to another network, such as a router, a modem, switch, hub, bridge, or other embedded device. MNA 50 may also include a combination of network entrance devices, such as a router and a high-speed modem, including a DSL modem and a cable modem, among others. The router may be a stand-alone device or integrated into the high-speed modem. In addition, MNA 50 may be a network appliance running an Internet Connection Sharing (“ICS”) routine for sharing a single connection to Internet 45 among network appliances 10-35.

The status information collected by MNA 50 regarding network activity in LAN 40 is transmitted to one or more CNAs, accessible by one or more controlling users. A controlling user accessing a CNA may passively analyze the information received from MNA 50 to oversee activity in LAN 40. Alternatively, a controlling user may analyze the information received from MNA 50 to determine whether any immediate or future action to control network activity in LAN 40 is to be taken. If so, the controlling user may direct MNA 50 to perform an action to control network activity in LAN 40 by sending a message to MNA 50 with a command to be executed on LAN 40.

For example, a CNA may be network appliance 20 used by a parent to monitor activity in network appliance 10 used by his children to access Internet 45. In another example, LAN 40 may be a business network and CNA 20 may be accessible by an IT employee to oversee the online activity of all employees working on network appliances in LAN 40. In yet another example, the CNAs may be remote network appliances 55-60 accessible by a parent while traveling away from his home network, e.g., LAN 40, to oversee online activity of his children. The CNA may also be a virtual private network (“VPN”) gateway or other remote gateway or appliance, e.g., gateway 65, that forwards the information received from MNA 50 to the controlling user, e.g., parent, which may be accessing network appliances 70-75 at work to oversee online activity of his children at their home LAN 40.

It should be understood by one skilled in the art that a single CNA may monitor one or more MNAs, and a single MNA may be monitored by one or more CNAs. It should also be understood by one skilled in the art that any one of appliances 10-35 and gateway 50 may be a MNA and/or a CNA simultaneously.

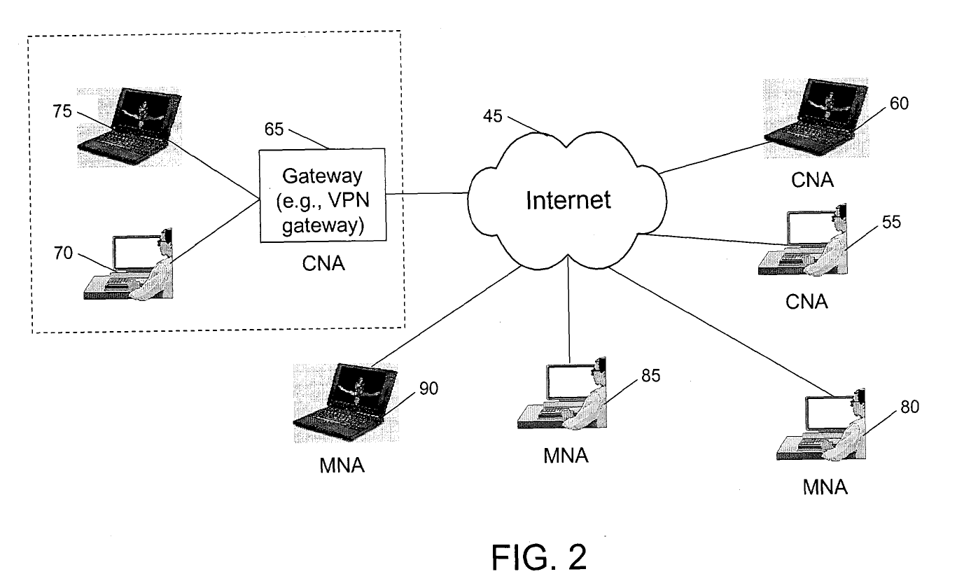

Referring now to FIG. 2, a schematic diagram of another exemplary embodiment of the network environment in which the present invention operates is described. In this embodiment, MNAs 80-90 are network appliances that connect to Internet 45 directly, such as PCs 80 and 85 and notebook 90. Each of MNAs 80-90 may be monitored by one or more of CNAs 55-65 simultaneously, and each of CNAs 55-65 may monitor one or more of MNAs 80-90 simultaneously.

MNAs 80-90 are each equipped with a monitoring engine to collect status information regarding the network activity of its users. The status information is transmitted to one or more of CNAs 55-65, which may passively oversee the network activity of MNAs 80-90 or analyze the information received to determine whether any immediate or future action to control the network activity of MNAs 80-90 is to be taken. If so, CNAs 55-65 may direct MNAs 80-90 to perform an action that control their network activity by sending a message to MNAs 80-90 with a command to be executed, for example, CNA 55 may direct MNA 80 to block a given web site or chat room.

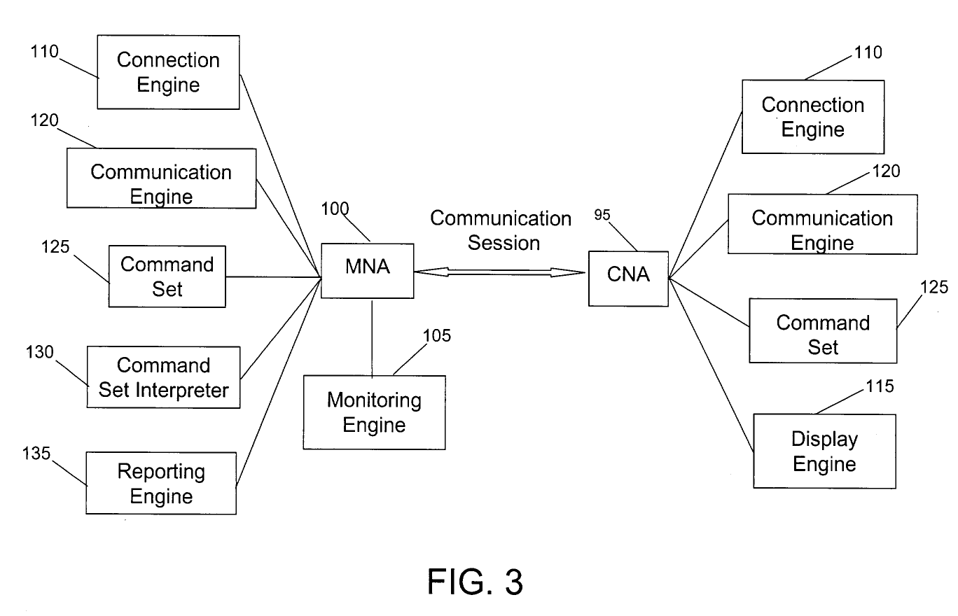

Referring now to FIG. 3, a schematic diagram of the software components used in a preferred embodiment of the present invention is described. The software components embedded in MNA 100 consist of: (1) monitoring engine 105; (2) connection engine 110; (3) communication engine 120; (4) command set 125; (5) command set interpreter 130; and (6) reporting engine 135. CNA 95 is equipped with three of the six components: (1) connection engine 110; (2) communication engine 120; and (3) command set 125. In addition, CNA 95 is equipped with display engine 115 to display the network activity information transmitted by MNA 100.

Monitoring engine 105 is a program embedded in MNA 100 for reading the contents of each network packet transmitted from/to MNA 100 to/from Internet 45 and determining the network activity represented in the packets, such as URLs accessed, chat rooms visited, e-mails sent and received, and instant messaging (“IM”) sessions, among others.

The information is transmitted to CNA 95 via communication engine 120 in one of four ways, depending on the type of IP addresses assigned to CNA 95 and MNA 100: (1) the transmission may be a bi-directional P2P transmission if both MNA 100 and CNA 95 have communicable IP addresses; (2) if MNA 100 has a communicable IP address but CNA 95 has a non-communicable IP address, the transmission may be a H-P2P transmission where MNA 100 may designate a local information buffer to store the network activity information for CNA 95 to pull such information periodically. MNA 100 may also designate a command buffer to receive commands sent by CNA 95 periodically; (3) if MNA 100 has a non-communicable IP address but CNA 95 has a communicable IP address, the transmission may be a H-P2P transmission where CNA 95 may designate a local information buffer for MNA 100 to send the network activity information periodically. CNA 95 may also designate a local command buffer to store control commands for MNA 100 to retrieve periodically; and (4) if both MNA 100 and CNA 95 have non-communicable addresses, the transmission may be a client-server transmission where MNA 100 and CNA 95 relay information by means of a server, e.g., an IM server.

MNA 100 determines the type of IP address assigned to CNA 95, i.e., communicable or non-communicable, by using connection engine 110. Connection engine 110 determines the type of IP address assigned to CNA 95, i.e., communicable or non-communicable, and selects the corresponding communication means to be used by the communication engine for exchanging network activity information between MNA 100 and CNA 95. In a preferred embodiment, connection engine 110 may be an IMC with MNA 100 and CNA 95 as buddies in the same IM network. MNA 100 is logged into an IM server with its own username and password, which may be selected by a controlling user upon MNA 100's configuration. The IM server may be any IM server used by an IM service, such as ICQ, AOL Instant Messenger (“AIM”), provided by America Online, Inc., of Dulles, Va., Yahoo! Messenger, provided by Yahoo!, Inc., of Sunnyvale, Calif., and MSN Messenger, provided by Microsoft Corporation, of Redmond, Wash., among others. The IMC is a program for making requests to the IM server, which fulfills the requests. By launching an IMC, MNA 100 can send instant messages to any user and network appliance on its buddy list.

Once MNA 100 is logged into an IM server, it sends instant messages containing its IP address to all of its buddies, i.e., to all the CNAs that may monitor and control the network activity collected by MNA 100, including CNA 95. The instant messages are first sent to the IM server and forwarded to the CNAs if they are online. If CNA 95 is not online when an instant message is sent, the IM server stores the instant message for later forwarding. When CNA 95 goes online, the IM server sends a notification to MNA 100 to inform MNA 100 of CNA 95's online status and it forwards the instant message containing MNA 100's IP address to CNA 95. CNA 95 then replies to the instant message sent by MNA 100 with an instant message to MNA 100 containing CNA 95's IP address.

Once MNA 100 has the IP address of CNA 95, it uses communication engine 120 to try to establish a P2P connection with CNA 95 to determine the type of IP address assigned to CNA 95, i.e., communicable or non-communicable, by sending a packet to CNA 95. If CNA 95 has a communicable IP address, it receives the packet and subsequently sends an acknowledgment packet to MNA 100. If CNA 95 has a non-communicable address, however, it does not receive MNA 100's packet nor it is able to send an acknowledgment packet to MNA 100. MNA 100 determines the type of IP address assigned to CNA 95 based on whether it receives the acknowledgment packet from CNA 95. MNA 100 then begins to transmit the network activity information to CNA 95 in one of the four ways described above, depending on the type of IP addresses assigned to MNA 100 and to CNA 95.

After receiving the information from MNA 100, CNA 95 may direct MNA 100 to perform actions to control the network activity monitored by MNA 100, such as blocking access to a given web site or chat room. CNA 95 directs MNA 100 to perform an action by using a command in command set 125 embedded in MNA 100. The commands are relayed to MNA 100 depending on its IP address, as described above.

Command set 125 is a list of commands that CNA 95 may use to direct MNA 100 to perform an action to control the network activity monitored by MNA 100, such as a “block” command to block MNA 100 from accessing a web site or chat room, a “disconnect” command to disconnect MNA 100 from Internet 45, and a “time out” command to limit the time MNA 100 is connected to Internet 45, among others. Command set interpreter 130 is provided in MNA 100 for it to retrieve the command sent by CNA 95 and execute the command.

MNA 100 may also include reporting engine 135 for recording network activity information into logs and sending the logs to CNA 95. The logs may be transmitted to CNA 95 via IM when CNA 95 is online, posted on a secure web site accessed only by the controlling user with a security key, or transmitted by other means, such as via electronic mail, voice mail, among others. The logs may also be periodically pulled by CNA 95 when CNA 95 is assigned a non-communicable address and MNA 100 is assigned a communicable IP address. The logs may be pulled by using FTP, or other network protocols.

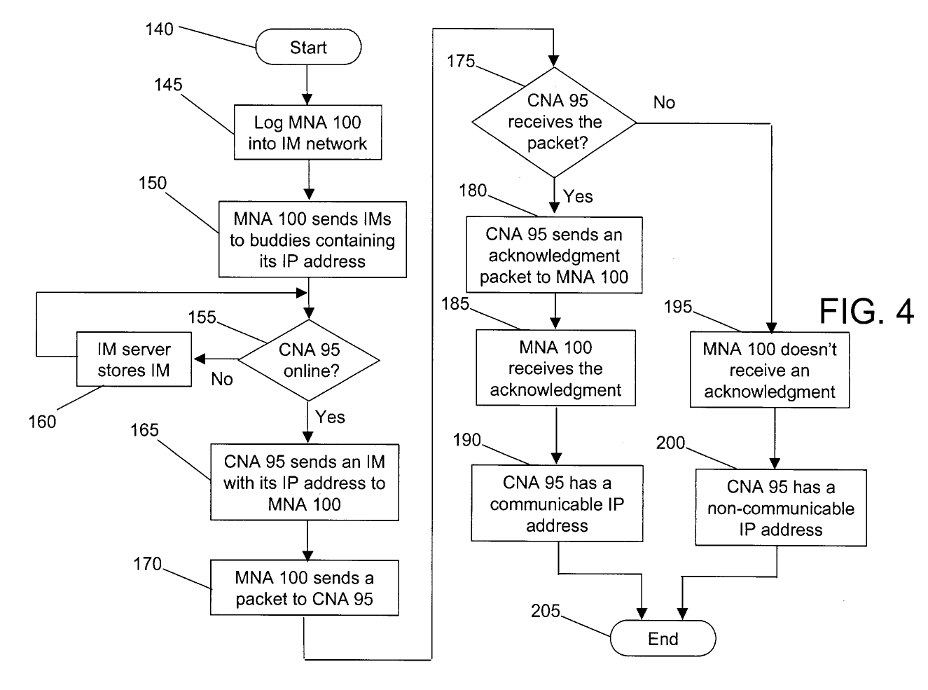

Referring now to FIG. 4, a flow chart for an exemplary IP discovery exchange between a MNA and a CNA is described. At step 145, connection engine 110 logs MNA 100 into an IM server of an IM network in which both MNA 100 and CNA 95 are buddies.

At step 150, MNA 100 sends instant messages containing its IP address to all of its buddies, i.e., to all the CNAs that may monitor and control the network activity collected by MNA 100, including CNA 95. The instant messages are first sent to the IM server and forwarded to the CNAs if they are online. If CNA 95 is not online when an instant message is sent (step 155), the IM server stores the instant message for later forwarding (step 160). When CNA 95 goes online, the IM server sends a notification to MNA 100 to inform MNA 100 of CNA 95's online status and it forwards the instant message containing MNA 100's IP address to CNA 95. CNA 95 then replies to the instant message sent by MNA 100 with an instant message to MNA 100 containing CNA 95's IP address (step 165).

Once MNA 100 has the IP address of CNA 95, it uses communication engine 120 to try to establish a P2P connection with CNA 95 to determine the type of IP address assigned to CNA 95, i.e., communicable or non-communicable, by sending a packet to CNA 95 (step 170).

If CNA 95 receives the packet (step 175), then it sends an acknowledgment packet to MNA 100 at step 180. MNA 100 receives the acknowledgment at step 185, regardless of whether its IP address is communicable or non-communicable, and it determines that CNA 95 has a communicable IP address at step 190.

Otherwise, if CNA 95 does not receive the packet sent by MNA 100 (step 175), it is not able to acknowledge the packet. MNA 100 then determines that CNA 95 has a non-communicable IP address (step 200) if it doesn't receive an acknowledgment packet from CNA 95 after a given time period (step 195).

It should be understood by one skilled in the art that CNA 95 determines whether MNA 100 has a communicable IP address based on whether it receives a packet from MNA 100 after it goes online. If CNA 95 receives the packet (step 180), then it knows that MNA 100 has a communicable IP address.

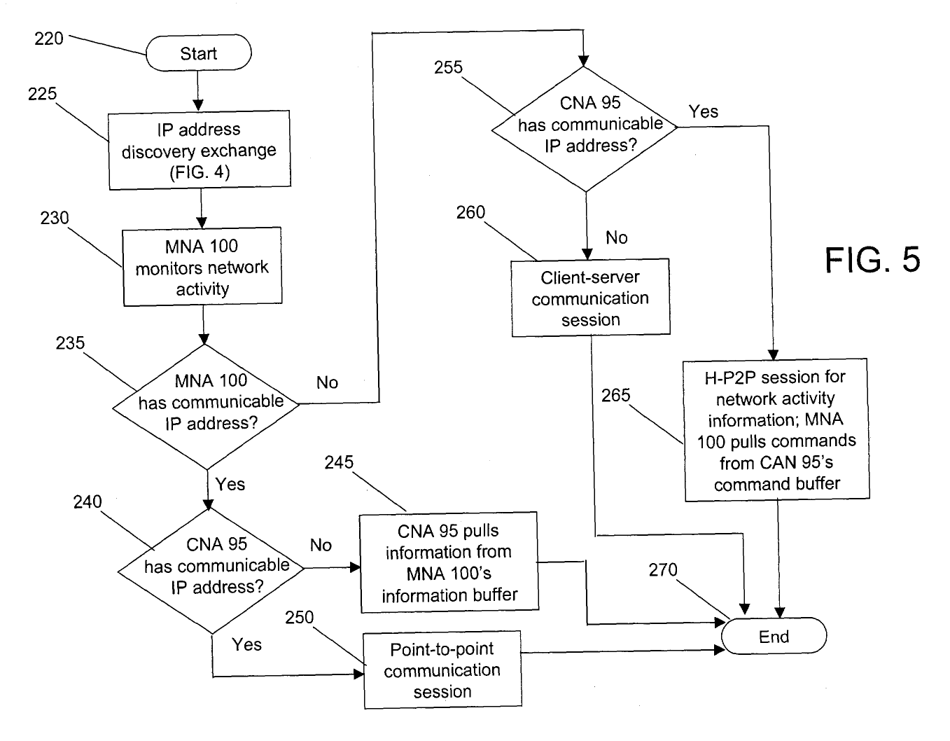

Referring now to FIG. 5, a flow chart for monitoring network activity and communicating the monitored activity to a CNA is described. At step 225, MNA 100 and CNA 95 engage in the IP discovery exchange described above with reference to FIG. 4. MNA 100 monitors the network activity at step 230, that is, MNA 100 runs monitoring engine 105 to read all network packets from/to MNA 100 to/from Internet 45 and determines the network activity represented in the packets. If MNA 100 has a communicable IP address (step 235) and CNA 95 has a communicable IP address as well (step 240), MNA 100 starts a P2P communication session with CNA 95 to transmit the network activity to CNA (step 250). CNA 95 may then passively analyze the network information or send commands from command set 125 to MNA 100 for it to perform an action that controls its network activity, such as blocking MNA 100 from entering a chat room.

If MNA 100 has a communicable IP address but CNA 95 does not (step 240), then MNA 100 may not be able to engage in a P2P communication session with CNA 95. Instead, MNA 100 and CNA 95 engage in a H-P2P session where MNA 100 may designate a local information buffer to store the network activity information for CNA 95 to pull such information periodically (step 245). MNA 100 may also designate a command buffer to receive commands sent by CNA 95 periodically. If neither MNA 100 nor CNA 95 has a communicable IP address, e.g. when both MNA 100 and CNA 95 sit behind firewalls with NAT, MNA 100 and CNA 95 may communicate by means of a client-server session, where MNA 100 and CNA 95 relay information by means of a server, e.g., an IM server. (step 260).

An H-P2P session may also be used when MNA 100 has a non-communicable address but CNA 95 has a communicable IP address (step 255). In this case, CNA 95 may designate a local information buffer for MNA 100 to send the network activity information periodically. CNA 95 may also designate a local command buffer to store control commands for MNA 100 to retrieve periodically (step 265).

It should be understood by one skilled in the art that MNA 100 records network activity into logs throughout the steps illustrated in FIG. 5. The information is recorded into logs using reporting engine 135. The logs may be transmitted to CNA 95 via an IMC when CNA 95 is online, posted on a secure web site accessed only by CNA 95 with a security key, or transmitted by other means, such as via electronic mail, voice mail, fax, among others.

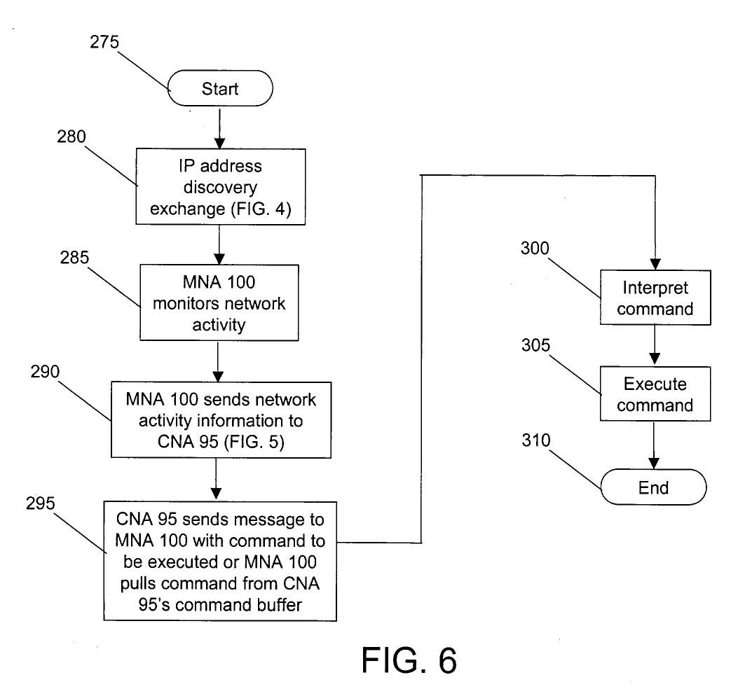

Referring now to FIG. 6, a flow chart for performing an action based on monitored network information is described. At step 280, MNA 100 and CNA 95 engage in the IP discovery exchange described above with reference to FIG. 4. MNA 100 monitors the network activity at step 285, that is, MNA 100 runs monitoring engine 105 to read all network packets from/to MNA 100 to/from Internet 45 and determines the network activity represented in the packets.

At step 290, MNA 100 transmits the network activity information to CNA 95 according to the steps described above with reference to FIG. 5. Upon receiving and analyzing the information, CNA 95 sends a message to MNA 100 with a command to be executed (step 295). Lastly, the command is interpreted (step 300) and executed (step 305) by MNA 100 using command set interpreter 130. For example, MNA 100 may block access to a given web site, or may interrupt its Internet connection for a limited period of time.

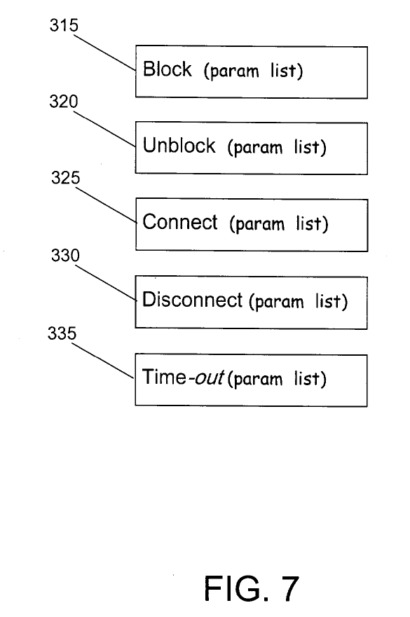

Referring now to FIG. 7, an illustrative diagram of a list of commands in the command set is described. Each command in command set 125 has a command name and a list of parameters corresponding to the command. Block command 315 is a command for blocking MNA 100 from performing a given network activity, such as accessing a web site, chat room, or newsgroup, or from viewing an image or audio file, or from running a given network service, such as IM. Block command 315 has a parameter list to specify the activity or service to be blocked. Unblock command 320 is a command for unblocking an activity or service previously blocked by block command 315.

Connect command 325 is a command for connecting MNA 100 to Internet 45 possibly after having disconnected MNA 100 from Internet 45 with disconnect command 330. Similar to block command 315, connect command 325 and disconnect command 330 have a parameter list to specify when MNA 100 is to be connected to or disconnected from Internet 45.

Command set 125 may also have command 335 to time-out MNA 100 from using Internet 45 or from using a web browser, IM, or other application. The parameter list associated with time-out command 335 may include the activity or service to be timed-out, among other parameters.

It should be understood by one skilled in the art that IM command set 125 may include additional commands not shown in FIG. 7.

Although particular embodiments of the present invention have been described above in detail, it will be understood that this description is merely for purposes of illustration. Specific features of the invention are shown in some drawings and not in others, and this is for convenience only and any feature may be combined with another in accordance with the invention. Steps of the described processes may be reordered or combined, and other steps may be included. Further variations will be apparent to one skilled in the art in light of this disclosure and are intended to fall within the scope of the appended claims.

What is claimed is:

1. A method for monitoring and controlling network activity, the method comprising:
screening network activity to collect network activity information associated to a monitoring network appliance without user intervention and in real-time;
transmitting the network activity information to a controlling network appliance in real-time; and
sending a command from the controlling network appliance to the monitoring network appliance to control the network activity of the monitoring network appliance in real-time, wherein the network activity comprises one or more of:
web browsing; e-mailing; instant messaging; peer-to-peer file sharing; chatting in chat rooms; and posting in bulletin boards.

2. The method of claim 1, further comprising determining a type of IP address assigned to the controlling network appliance and a type of IP address assigned to the monitoring network appliance prior to transmitting the network activity information to the controlling network appliance.

3. The method of claim 1, wherein transmitting network activity information to the controlling network appliance comprises selecting a communication routine from a plurality of communication routines for transmitting the network activity information, wherein the communication routine is selected according to the type of IP address assigned to the controlling network appliance and the type of IP address assigned to the monitoring network appliance.

4. The method of claim 3, wherein the plurality of communication routines comprises one or more of: a bi-directional point-to-point communication routine; a hybrid point-to-point communication routine; and a client-server communication routine.

5. The method of claim 1, wherein transmitting network activity information to the controlling network appliance comprises transmitting the network activity information using a bi-directional point-to-point communication routine if the type of IP address assigned to the monitoring network appliance and the type of IP address assigned to the controlling network appliance comprise a communicable IP address.

6. The method of claim 1, wherein transmitting network activity information to the controlling network appliance comprises transmitting the information using a hybrid point-to-point communication routine if either the type of IP address assigned to the controlling network appliance or the type of IP address assigned to the monitoring network appliance comprises a non-communicable IP address.

7. The method of claim 1, wherein transmitting network activity information to the controlling network appliance comprises transmitting the information using a client-server communication routine if the type of IP address assigned to the monitoring network appliance and the type of IP address assigned to the controlling network appliance comprise a non-communicable IP address.

8. The method of claim 1, wherein sending a command from the controlling network appliance to the monitoring network appliance to control the network activity of the monitoring network appliance in real-time comprises sending one or more of: a block command; an unblock command; a connect command; a disconnect command; and a time-out command.

9. The method of claim 1, further comprising interpreting and executing the command in the monitoring network appliance to control the network activity of the monitoring network appliance.

10. The method of claim 1, further comprising:
recording the network activity information into logs; and
transmitting the logs to the controlling network appliance.

11. The method of claim 1, further comprising displaying the network activity information in the controlling network appliance.

12. The method of claim 2, wherein determining a type of IP address assigned to the controlling network appliance and a type of IP address assigned to the monitoring network appliance prior to transmitting the network activity information to the controlling network appliance comprises using an instant messaging client in the monitoring network appliance and an instant messaging client in the controlling network appliance for exchanging an IP address assigned to the controlling network appliance and an IP address assigned to the monitoring network appliance between the controlling network appliance and the monitoring network appliance.

13. The method of claim 12, wherein using an instant messaging client comprises providing at least one buddy list in the monitoring network appliance, the at least one buddy list comprising at least one controlling network appliance.

14. The method of claim 1, further comprising:
screening network activity to collect network activity information associated to at least one monitoring network appliance without user intervention and in real-time;
transmitting the network activity information to at least one controlling network appliance in real-time; and
sending a command from the at least one controlling network appliance to the at least one monitoring network appliance to control the network activity of the at least one monitoring network appliance in real-time.

15. A method for monitoring and controlling network activity, the method comprising:
screening network activity to collect network activity information associated to a monitoring network appliance without user intervention and in real-time;
transmitting the network activity information to a controlling network appliance in real-time based on which type of IP address is assigned to the controlling network appliance and which type of IP address is assigned to the monitoring network appliance; and
sending a command from the controlling network appliance to the monitoring network appliance to control the network activity of the monitoring network appliance in real-time.

16. The method of claim 15, wherein screening network activity comprises screening one or more of: web browsing; e-mailing; instant messaging; peer-to-peer file sharing; chatting in chat rooms; and posting in bulletin boards.

17. The method of claim 15, wherein transmitting the network activity information to the controlling network appliance comprises selecting a communication routine from a plurality of communication routines for transmitting the network activity information, wherein the communication routine is selected according to the type of IP address assigned to the controlling network appliance and the type of IP address assigned to the monitoring network appliance.

18. The method of claim 17, wherein the plurality of communication routines comprises one or more of: a bi-directional point-to-point communication routine; a hybrid point-to-point communication routine; and a client-server communication routine.

19. The method of claim 15, wherein transmitting the network activity information to the controlling network appliance comprises transmitting the network activity information using a bi-directional point-to-point communication routine if the type of IP address assigned to the monitoring network appliance and the type of IP address assigned to the controlling network appliance comprise a communicable IP address.

20. The method of claim 15, wherein transmitting the network activity information to the controlling network appliance comprises transmitting the information using a hybrid point-to-point communication routine if either the type of IP address assigned to the controlling network appliance or the type of IP address assigned to the monitoring network appliance comprises a non-communicable IP address.

21. The method of claim 15, wherein transmitting the network activity information to the controlling network appliance comprises transmitting the information using a client-server communication routine if the type of IP address assigned to the monitoring network appliance and the type of IP address assigned to the controlling network appliance comprise a non-communicable IP address.

22. The method of claim 15, wherein sending a command from the controlling network appliance to the monitoring network appliance to control the network activity of the monitoring network appliance in real-time comprises sending one or more of: a block command; an unblock command; a connect command; a disconnect command; and a time-out command.

23. The method of claim 15, further comprising interpreting and executing the command in the monitoring network appliance to control the network activity of the monitoring network appliance.

24. The method of claim 15, further comprising:
recording the network activity information into logs; and
transmitting the logs to the controlling network appliance.

25. The method of claim 15, further comprising displaying the network activity information in the controlling network appliance.

26. The method of claim 15, further comprising using an instant messaging client in the monitoring network appliance and an instant messaging client in the controlling network appliance for exchanging an IP address assigned to the controlling network appliance and an IP address assigned to the monitoring network appliance between the controlling network appliance and the monitoring network appliance.

27. The method of claim 26, wherein using an instant messaging client comprises providing at least one buddy list in the monitoring network appliance, the at least one buddy list comprising at least one controlling network appliance.

28. The method of claim 15, further comprising:
screening network activity to collect network activity information associated to at least one monitoring network appliance without user intervention and in real-time;
transmitting the network activity information to at least one controlling network appliance in real-time based on which type of IP address is assigned to the at least one controlling network appliance and which type of IP address is assigned to the at least one of monitoring network appliances; and
sending a command from the at least one controlling network appliance to the at least one monitoring network appliance to control the network activity of the at least one monitoring network appliance in real-time.

29. A method for monitoring and controlling network activity, the method comprising:
screening network activity to collect network activity information associated to a monitoring network appliance without user intervention and in real-time;
transmitting the network activity information to a controlling network appliance in real-time; and
sending a command without user intervention from the controlling network appliance to the monitoring network appliance to control the network activity of the monitoring network appliance in real-time.

30. The method of claim 29, wherein screening network activity comprises screening one or more of: web browsing; e-mailing; instant messaging; peer-to-peer file sharing; and chatting in chat rooms; and posting in bulletin boards.

31. The method of claim 29, further comprising determining a type of IP address assigned to the controlling network appliance and a type of IP address assigned to the monitoring network appliance prior to transmitting the network activity information to the controlling network appliance.

32. The method of claim 29, wherein transmitting the network activity information to the controlling network appliance comprises selecting a communication routine from a plurality of communication routines for transmitting the network activity information, wherein the communication routine is selected according to the type of IP address assigned to the controlling network appliance and the type of IP address assigned to the monitoring network appliance.

33. The method of claim 32, wherein the plurality of communication routines comprises one or more of: a bi-directional point-to-point communication routine; a hybrid point-to-point communication routine; and a client-server communication routine.

34. The method of claim 29, wherein transmitting the network activity information to the controlling network appliance comprises transmitting the network activity information using a bi-directional point-to-point communication routine if the type of IP address assigned to the monitoring network appliance and the type of IP address assigned to the controlling network appliance comprise a communicable IP address.

35. The method of claim 29, wherein transmitting the network activity information to the controlling network appliance comprises transmitting the information using a hybrid point-to-point communication routine if either the type of IP address assigned to the controlling network appliance or the type of IP address assigned to the monitoring network appliance comprises a non-communicable IP address.

36. The method of claim 29, wherein transmitting the network activity information to the controlling network appliance comprises transmitting the information using a client-server communication routine if the type of IP address assigned to the monitoring network appliance and the type of IP address assigned to the controlling network appliance comprise a non-communicable IP address.

37. The method of claim 29, wherein sending a command from the controlling network appliance to the monitoring network appliance to control the network activity of the monitoring network appliance in real-time comprises sending one or more of: a block command; an unblock command; a connect command; a disconnect command; and a time-out command.

38. The method of claim 29, further comprising interpreting and executing the command in the monitoring network appliance to control the network activity of the monitoring network appliance.

39. The method of claim 29, further comprising:
recording the network activity information into logs; and
transmitting the logs to the controlling network appliance.

40. The method of claim 29, further comprising displaying the network activity information in the controlling network appliance.

41. The method of claim 29, further comprising using an instant messaging client in the monitoring network appliance and an instant messaging client in the controlling network appliance for exchanging an IP address assigned to the controlling network appliance and an IP address assigned to the monitoring network appliance between the controlling network appliance and the monitoring network appliance.

42. The method of claim 41, wherein using an instant messaging client comprises providing at least one buddy list in the monitoring network appliance, the at least one buddy list comprising at least one controlling network appliance.

43. The method of claim 29, further comprising sending a message to a third party without user intervention to notify the third party of the network activity of the monitoring network appliance, the message comprising one or more of: an e-mail; a phone call; a fax; and an instant message.

44. The method of claim 29, further comprising:
screening network activity to collect network activity information associated to at least one monitoring network appliance without user intervention and in real-time;
transmitting the network activity information to at least one controlling network appliance in real-time; and
sending a command without user intervention from the at least one controlling network appliance to the at least one monitoring network appliance to control the network activity of the at least one monitoring network appliance in real-time.

45. A monitoring network appliance for monitoring and controlling network activity of a plurality of network appliances in a local area network, the monitoring network appliance comprising:
a monitoring engine for gathering information on network activity without user information and in real-time;
a communication engine comprising a plurality of communication routines for transmitting the network activity information to at least one controlling network appliance in real-time; and
a connection engine for determining which type of IP address is assigned to the controlling network appliance and selecting a communication routine from the plurality of communication routines for transmitting the network activity information to the controlling network appliance, wherein the communication routine is selected based on the type of IP address assigned to the controlling network appliance.

46. The monitoring network appliance of claim 45, wherein the monitoring network appliance comprises a network gateway.

47. The monitoring network appliance of claim 45, wherein the network activity comprises one or more of: web browsing; e-mailing; instant messaging; peer-to-peer file sharing; chatting in chat rooms; and posting in bulletin boards.

48. The monitoring network appliance of claim 45, wherein the plurality of communication routines comprises one or more of: a bi-directional point-to-point communication routine; a hybrid point-to-point communication routine; and a client-server communication routine.

49. The monitoring network appliance of claim 45, wherein the communication routine from the plurality of communication routines comprises a bi-directional point-to-point communication routine if the type of IP address assigned to the controlling network appliance comprises a communicable IP address.

50. The monitoring network appliance of claim 45, wherein the communication routine from the plurality of communication routines comprises a hybrid point-to-point communication routine if the type of IP address assigned to the controlling network appliance comprises a non-communicable IP address.

51. The monitoring network appliance of claim 45, wherein the monitoring network appliance and the controlling network appliance comprise a command set.

52. The monitoring network appliance of claim 51, wherein the command set comprises a plurality of commands comprising one or more of: a block command; an unblock command; a connect command; a disconnect command; and a time-out command.

53. The monitoring network appliance of claim 45, wherein the controlling network appliance comprises a communication engine for receiving messages from and sending a command in the command set to the monitoring network appliance to control the network activity of one or more of the plurality of network appliances in the local area network.

54. The monitoring network appliance of claim 53, wherein the controlling network appliance comprises a routine for sending the command without user intervention.

55. The monitoring network appliance of claim 45, further comprising a command set interpreter for interpreting and executing a command from the command set.

56. The monitoring network appliance of claim 45, further comprising:
a reporting engine for recording the network activity information into logs; and
a routine for transmitting the logs to the controlling network appliance.

57. The monitoring network appliance of claim 45, wherein the controlling network appliance comprises a display engine for displaying the network activity information in the controlling network appliance.

58. The monitoring network appliance of claim 45, further comprising an instant messaging client for exchanging an IP address assigned to the monitoring network appliance with an IP address assigned to the controlling network appliance.

59. The monitoring network appliance of claim 45, wherein the controlling network appliance comprises an instant messaging client for exchanging an IP address assigned to the controlling network appliance with an IP address assigned to the monitoring network appliance.

60. The monitoring network appliance of claim 45, further comprising at least one buddy list, wherein the at least one buddy list comprises at least one controlling network appliance.
